(19) United States
(12) Patent Application Publication
(10) Pub. No.: US 2026/0170400 A1
(43) Pub. Date: Jun. 18, 2026

(54) POLICY-CENTRIC DATA COLLECTION FOR DISTRIBUTED MACHINE-LEARNING

(71) Applicant: Red Hat, Inc., Raleigh, NC (US)

(72) Inventors: Leigh Griffin, Waterford (IE); Dimitri Saridakis, Waterford (IE)

(21) Appl. No.: 18/980,989

(22) Filed: Dec. 13, 2024

(51) Int. Cl. G06N 20/00

(52) U.S. Cl. CPC G06N 20/00

(57) ABSTRACT

A computer system can: identify a training target associated with training a machine-learned model; communicate, to a remote computing device, a data capture policy that is implementable by the remote computing device to cause the remote computing device to capture data responsive to the training target; obtain a component training dataset from the remote computing device, the component training dataset comprising data captured according to the data capture policy; train the machine-learned model using an aggregate training dataset comprising the component training dataset aggregated with a plurality of additional component training datasets from a plurality of additional remote computing devices to generate an update for the machine-learned model; and communicate an update for the machine-learned model to the remote computing device for updating a local instance of the machine-learned model at the remote computing device.

### BACKGROUND

Machine-learning is a field of study in artificial intelligence (AI) that focuses on creating systems that can be trained to learn patterns and features in data and extrapolate from that data to new data without being explicitly programmed or trained on the new data.

### SUMMARY

The present disclosure provides systems and methods for policy-centric data collection for distributed machine-learning.

In one implementation, a computer system is provided. The computer system includes a non-transitory, computer-readable memory and a processor device coupled to the memory. The processor device is to identify a training target associated with training a machine-learned model. The processor device is to communicate, to a remote computing device, a data capture policy that is implementable by the remote computing device to cause the remote computing device to capture data responsive to the training target. The processor device is to obtain a component training dataset from the remote computing device, the component training dataset comprising data captured according to the data capture policy. The processor device is to train the machine-learned model using an aggregate training dataset comprising the component training dataset aggregated with a plurality of additional component training datasets from a plurality of additional remote computing devices to generate an update for the machine-learned model. The processor device is to communicate an update for the machine-learned model to the remote computing device for updating a local instance of the machine-learned model at the remote computing device.

In another implementation, a computer-implemented method is provided. The computer-implemented method includes identifying a training target associated with training a machine-learned model. The computer-implemented method includes communicating, to a remote computing device, a data capture policy that is implementable by the remote computing device to cause the remote computing device to capture data responsive to the training target. The computer-implemented method includes obtaining a component training dataset from the remote computing device, the component training dataset comprising data captured according to the data capture policy. The computer-implemented method includes training the machine-learned model using an aggregate training dataset comprising the component training dataset aggregated with a plurality of additional component training datasets from a plurality of additional remote computing devices to generate an update for the machine-learned model. The computer-implemented method includes communicating the update for the machine-learned model to the remote computing device for updating a local instance of the machine-learned model at the remote computing device.

In another implementation, a non-transitory, computer-readable memory is provided. The non-transitory, computer-readable memory can store instructions to cause a processor device to identify a training target associated with training a machine-learned model. The non-transitory, computer-readable memory can store instructions to cause a processor device to communicate, to a remote computing device, a data capture policy that is implementable by the remote computing device to cause the remote computing device to capture data responsive to the training target. The non-transitory, computer-readable memory can store instructions to cause a processor device to obtain a component training dataset from the remote computing device, the component training dataset comprising data captured according to the data capture policy. The non-transitory, computer-readable memory can store instructions to cause a processor device to train the machine-learned model using an aggregate training dataset comprising the component training dataset aggregated with a plurality of additional component training datasets from a plurality of additional remote computing devices to generate an update for the machine-learned model. The non-transitory, computer-readable memory can store instructions to cause a processor device to communicate the update for the machine-learned model to the remote computing device for updating a local instance of the machine-learned model at the remote computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an example system according to some implementations.

FIG. 2 is a data flow diagram according to some implementations.

FIG. 3 depicts a flowchart diagram of an example method according to some implementations.

FIG. 4 depicts a flowchart diagram of an example method according to some implementations.

FIG. 5 is a block diagram of an example system according to some implementations.

FIG. 6 is a block diagram of a computing device suitable for implementing systems and methods according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Distributed machine-learning can refer to providing for deployment of machine-learned models across multiple remote computing devices, which are typically managed by a model hosting system that stores central versions or instances of the machine-learned models. The remote computing devices may receive instances of the machine-learned models from the model hosting system and implement the instances of the models using computing resources available at the remote computing device. One common example of distributed machine-learning is the deployment of machine-learned models among internet-of-things (IoT) devices. Another example of distributed machine-learning includes a model hosting system that is or is within a datacenter (e.g., a server within the datacenter) and remote computing devices that are not within the datacenter. The remote computing devices can gather data from their environment, e.g. from use of the machine-learned models or from data capture devices such as sensors at the remote computing devices. For instance, the remote computing devices can be or can include sensor stations, IoT devices, or other devices that are generally positioned to facilitate data collection. For example, the remote computing devices may include weather sensors, humidity sensors, temperature sensors, ambient light sensors, ambient noise sensors, or other sensors configured to capture data about the physical environment of the remote computing devices. The remote computing devices may also include network monitoring systems, resource monitoring systems, or other systems configured to capture data about the computing environment of the remote computing devices.

The model hosting system can additionally receive communications from the remote computing devices including the data captured by the remote computing devices. The data from the remote computing devices can be used to train or update the machine-learned models at the model hosting system. For example, if a machine-learned model is a large language model, language data captured by a remote computing device may be used to train the large language model to improve language predictions from the model. The updates for the models can then be distributed to the remote computing devices. In this manner, the remote computing devices can be enabled to utilize up-to-date machine-learned models even if the remote computing devices lack the computing resources to train the machine-learned models. For example, the remote computing devices may have an onboard memory and a size of the onboard memory may be insufficient to store a training dataset used to train the machine-learned model. As another example, a processor device on the remote computing devices may perform a number of operations per second, which may be inadequate to both support the operations for performing the primary function(s) of the remote computing devices and simultaneously perform operations associated with a training process for the machine-learned models.

As the number of remote computing devices scales, it can become increasingly challenging to manage the devices communicating with the model deployment system and/or the volume of data being communicated to the model deployment system. For example, a model hosting system may receive generally duplicate or redundant data from two or more remote computing devices that are configured to observe a similar or same environment. Consider that, for example, a first remote computing device of a weather station and a second remote computing device of the same weather station that are both configured to measure rainfall may each provide identical or near identical data to the model hosting system. As another example, the model hosting system may receive erroneous data, poor quality data, or other data that is otherwise undesirable. For example, a malfunctioning sensor may transmit data that is largely or entirely noise or zero values. Transmitting this data could consume significant computing resources, especially during continuous operation, but could provide no value or even negative value to the model hosting system. For instance, this data could contribute noise or skewed distributions in training datasets, which could negatively impact performance of models trained on the training datasets.

Example aspects of the present disclosure provide for policy-centric data collection that can provide for a more efficient and higher quality data aggregation approach for training machine-learned models. More particularly, the model hosting system can identify a training target associated with training a machine-learned model. The training target can be an aspect or attribute of the machine-learned model, training data, and/or output of the machine-learned model that is to be improved by additional training.

Based on the training target, the model hosting system can determine or generate a data capture policy. The data capture policy can be implementable by a remote computing device to cause the remote computing device to capture data responsive to the training target. For instance, the data capture policies can specify or describe data capture parameters that the remote computing device can implement to modify operation of the remote computing device to facilitate the data capture responsive to the training target. The data capture policies can include, for example, operational parameters, configuration data, conditions, constraints, or other operational limitations on the functionality of the remote computing device to facilitate data capture at the remote computing device. Furthermore, the data capture parameters can define type, density, condition, maximum or minimum dataset size, or other attributes of data useful for the training target. For example, if a remote computing device is communicating redundant or poor quality data, a data capture policy may specify or limit a bandwidth, data transmission interval, data density, or other communication parameter to cause the remote computing device to consume fewer computing resources associated with transmitting the data. As another example, a data capture policy may increase a bandwidth or data transmission interval if a remote computing device is capturing data descriptive of conditions that match those targeted by the training target. The data capture policy may also specify one or more rules or heuristics with respect to the captured data. For example, in some implementations, the data capture policy may describe a filtering rule to be applied to the captured data.

Furthermore, in some implementations, the data capture policies can be determined based on capabilities of a remote computing device. For example, a remote computing device can transmit capability data descriptive of one or more capabilities of the remote computing device such as, for example, computing resource availability data, supported operation data, data capture device type data, calibration history data, or other data that provides for the model hosting system to determine data capture policies that are within a capability of the remote computing device on which the data capture policies are to be implemented.

Using the data captured according to the data capture policy, the remote computing device can generate a component training dataset. For example, the remote computing device can obtain and store the data from the data capture device while implementing and/or subsequent to implementing the data capture policy (e.g., the data capture parameters specified by the data capture policy). Additionally or alternatively, in some implementations, the remote computing device can apply the rules or heuristics specified by the data capture policy to the captured data to filter or otherwise treat the data prior to inclusion in the component training dataset. For example, the remote computing device can tag data captured by the data captured device for inclusion in the component training dataset based on the data capture policy. The data tagged for inclusion in the component training dataset from a particular remote computing device can be beneficial for training not only a machine-learned model at the remote computing device, but also for a machine-learned model deployed at another remote computing device managed by the model hosting system, including another instance of the same machine-learned model or a different machine-learned model. As another example, if the remote computing devices are capable of locally updating their respective local instances of the machine-learned model, including relevant training data in the component training dataset can provide for updating the models at the centralized model hosting system to disseminate the improvements to the models more uniformly across other remote computing devices.

The model hosting system can receive the component training dataset from a remote computing device. The model hosting system can further aggregate the component training dataset with a plurality of additional component training datasets from a plurality of additional remote computing devices to generate an aggregate training dataset. The aggregate training dataset can include various training data items from many varied domains of remote computing devices. Furthermore, the aggregate training dataset can include reduced instances of duplicate or redundant data, poor quality data, irrelevant data, and other undesirable data due to the data capture policies. In this manner, the model hosting system can provide a varied, targeted, clean, and representative set of data for training the machine-learned model. The model hosting system (or another computing system) can train the machine-learned model using the aggregate training dataset to generate an update for the machine-learned model. The update can be any suitable update format such as, for example, a new file or data structure containing new model parameters, a delta over an existing instance of the machine-learned model, or other suitable update. The model hosting system can communicate the update to the remote computing device for updating the local instance of the machine-learned model at the remote computing device. Furthermore, the update can be communicated to other remote computing devices that utilize the same model, including remote computing devices that may or may not have contributed data to the aggregate training dataset.

Systems and methods according to example aspects of the present disclosure can provide a number of technical effects and benefits, including improvements to computing technology. For instance, by capturing data according to a data capture policy that is responsive to a training target, a remote computing device can be prevented from capturing, storing, and/or transmitting data that is not responsive to the training target to the model hosting system. These actions can otherwise consume and waste significant computing resources that could otherwise be provided for other tasks, such as the primary functionality of the remote computing devices. This, in turn, can provide for reduced cost associated with the remote computing devices by providing for lowered computing resource requirements for capturing, storing, or transmitting data (e.g., smaller memory, reduced power consumption, etc.). Furthermore, this can provide for reduced cost associated with operating the remote computing devices and/or the model hosting system by providing reduced network resource requirements associated with the transmission of undesired data, such as reduced bandwidth consumption, reduced power consumption, improved capability to transmit over networks or regions having reduced overall bandwidth, and so on.

Furthermore, by training the machine-learned model using an aggregate training dataset comprising component training datasets captured according to the data capture policy, the systems and methods described herein can provide improved performance of machine-learned models. This, in turn, can provide for improved accuracy of outputs from the machine-learned models. For example, the present disclosure can provide for more varied training datasets covering a wider range of data conditions than some existing approaches and datasets having reduced duplicate or irrelevant data. This, in turn, can provide for improved quality of trained models due to the removal of irrelevant data from the training dataset and the avoidance of skewed training results due to duplicate or redundant data. Furthermore, this can provide for models that have an improved responsivity and consistency across more varied operational scenarios, including scenarios that would otherwise be underrepresented in data captured uniformly from observed conditions.

Additionally, by capturing data according to data capture policies that are determined relative to real-time condition data such as, for example, remote computing device capability data, time, weather conditions, computing environment conditions, movement or reconfiguration of remote computing devices, and so on, the model hosting system can orchestrate capture of data that is responsive to real-time needs of the machine-learned models. For example, the model hosting system can identify a training target by recognizing a present shortcoming in a machine-learned model, such as an underrepresented condition in training data, a scenario or condition where it is recognized that a model is performing with relatively poorer quality, or some other unexpected condition and coordinate with the remote computing devices to gather data to address the unexpected condition without intervention by a human operator. As another example, the model hosting system can modify data capture policies across a plurality of remote computing devices to account for the addition of or removal of remote computing devices to the set of managed remote computing devices. For example, the model hosting system can orchestrate data capture policies that capture a new type of data for a newly-added model that utilizes the new type of data or terminate capture of data that is not useful to the presently managed remote computing devices or machine-learned models. This can provide for distributed model systems that are more robust to unexpected events or real-time changes in the makeup of the system.

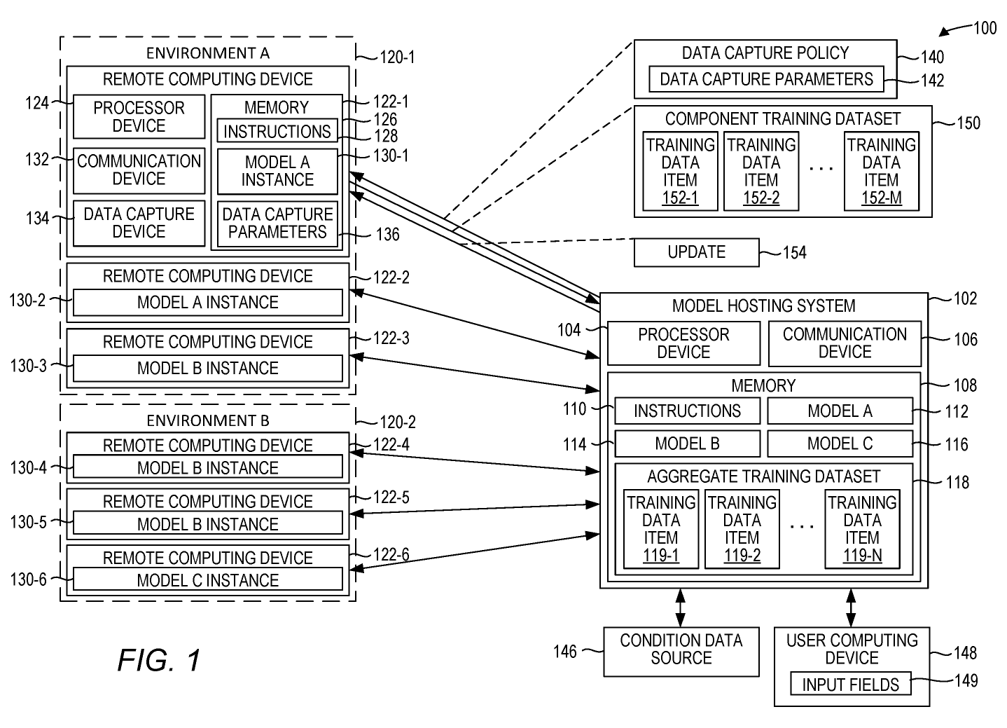

Referring now to the Figures, example aspects of the present disclosure will be discussed in more detail for the purpose of illustration. FIG. 1 is a block diagram of an example system 100 according to some implementations. The system 100 includes a model hosting system 102. The model hosting system 102 can include a processor device 104 to perform operations described herein. Furthermore, the model hosting system 102 can include a communication device 106. The communication device 106 can facilitate communication (e.g., via one or more networks) with other components and/or systems described herein. The model hosting system 102 can further include a memory 108 coupled to the processor device 104. The memory 108 can store instructions 110 that cause the processor device 104 to perform the operations described herein.

The memory 108 can store a plurality of machine-learned models, including a first machine-learned model 112, a second machine-learned model 114, and a third machine-learned model 116. It should be understood that more or fewer models can be stored in the memory 108. The first machine-learned model 112, the second machine-learned model 114, and/or the third machine-learned model 116 stored at the model hosting system 102 can be master instances of the models. For example, the first machine-learned model 112, the second machine-learned model 114, and/or the third machine-learned model 116 can be a most updated version of the models. Furthermore, the memory 108 can store an aggregate training dataset 118 including a plurality of training data items 119-1 through 119-N (collectively referred to as training data items 119). The aggregate training dataset 118 can be or can include training data items 119 that are or were previously used to train some or all of the first machine-learned model 112, the second machine-learned model 114, and/or the third machine-learned model 116.

The system 100 can cover one or more environments, including a first environment 120-1, a second environment 120-2, and/or additional environments (collectively referred to as environments 120). More or fewer environments may be covered by the system 100. As used herein, an environment 120 refers to a physical environment, such as a location, building, municipality, city, region, or other geospatial division, a computing environment, such as a network, server, computing system, or other division of computing resources, or any other suitable type of environment. Each environment 120 can include one or more remote computing devices 122. In the example of FIG. 1, the first environment 120-1 includes a first remote computing device 122-1, a second remote computing device 122-2, and a third remote computing device 122-3, while the second environment 120-2 includes a fourth remote computing device 122-4, a fifth remote computing device 122-5, and a sixth remote computing device 122-6. It should be understood that more or fewer remote computing devices 122 can be included in an environment 120. Each of the remote computing devices 122 can be in communication (e.g., via one or more networks) with the model hosting system 102.

Referring more particularly to the first remote computing device 122-1, components of the remote computing devices 122 will be discussed in detail. For the purpose of illustration, some components depicted with respect to the first remote computing device 122-1 are omitted from the depictions of other remote computing devices 122. It should be understood that components discussed with respect to the first remote computing device 122-1 may or may not be present at or within the other remote computing devices 122, unless otherwise indicated. The remote computing device 122 includes a processor device 124 and a memory 126 coupled to the processor device 124. The memory 126 can store instructions 128 that cause the processor device 124 to perform operations described herein. The operations can be associated with a primary function of the first remote computing device 122-1. For example, if the first remote computing device 122-1 is an IoT device such as a smart thermostat, some of the operations may be associated with performing functions associated with a smart thermostat, such as measuring a temperature of a building, controlling a heating and/or cooling system to climate control the building, and so on. Furthermore, the operations can be associated with policy-centric data capture, as described herein.

The memory 126 can additionally store a local first machine-learned model instance 130-1. For instance, the first machine-learned model instance 130-1 may be utilized by the primary functionality of the first remote computing device 122-1. The local first machine-learned model instance 130-1 can be a local instance of the first machine-learned model 112 of the model hosting system 102. For instance, the first remote computing device 122-1 can communicate with the model hosting system 102 by a communication device 132 to obtain the local first machine-learned model instance 130-1.

The local first machine-learned model instance 130-1 may be identical to the first machine-learned model 112, in some implementations. For example, in some implementations, the processor device 124 may have inadequate processing capability to perform operations associated with training the local first machine-learned model instance 130-1. As another example, in some implementations, the memory 126 may have an inadequate size to store a training dataset for training the local first machine-learned model instance 130-1. Additionally or alternatively, in some implementations, the local first machine-learned model instance 130-1 may differ slightly from the instance of the first machine-learned model 112 at the model hosting system 102. For example, the first remote computing device 122-1 may perform some limited local training of the local first machine-learned model instance 130-1 using data captured at the first remote computing device 122-1.

Other remote computing devices 122 may include local instances 130 of the models of the model hosting system 102. In the example of FIG. 1, the second remote computing device 122-2 includes a second local first machine-learned model instance 130-2, which may correspond to the first machine-learned model 112 of the model hosting system 102 in the same manner as the local first machine-learned model instance 130-1 of the first remote computing device 122-1. Similarly, the third remote computing device 122-3, the fourth remote computing device 122-4, and the fifth remote computing device 122-5 can respectively include a third local instance 130-3, a fourth local instance 130-4, and a fifth local instance 130-5 that each correspond to the second machine-learned model 114 of the model hosting system 102. Finally, the sixth remote computing device 122-6 can include a sixth local instance 130-6 that corresponds to the third machine-learned model 116 of the model hosting system 102. These local instances 130 will be used to explain example policy-centric data aggregation in a distributed system for the purposes of illustration only. It should be understood that any suitable combination of local instances 130 may occur within the scope of the present disclosure.

The first remote computing device 122-1 can capture data from or relating to the first environment 120-1 by a data capture device 134. The data capture device 134 can be any suitable device for obtaining, processing, and/or analyzing data. One example data capture device 134 is a sensor device, such as, but not limited to, a weather sensor, a humidity sensor, a temperature sensor, an ambient light sensor, or an ambient noise sensor. Other example data capture devices 134 include network monitoring systems, resource monitoring systems, or other systems configured to capture data about the computing environment of the first remote computing device 122-1. The data capture device 134 can operate based on one or more data capture parameters 136. The data capture parameters 136 can include parameters that are implementable to modify operational aspects of the first remote computing device 122-1, such as, but not limited to, operational parameters, configuration data, conditions, constraints, or other operational limitations on the functionality of the first remote computing device 122-1 to facilitate data capture at the first remote computing device 122-1. Furthermore, the data capture parameters 136 can define type, density, condition, maximum or minimum dataset size, or other attributes of data captured by the data capture device 134. The data capture parameters 136 may be stored by the memory 126. In some implementations, for example, the data capture parameters 136 are defined by one or more data capture policies.

More particularly, the model hosting system 102 can identify a training target and determine a data capture policy 140 responsive to the training target. The data capture policy 140 can be implementable by the first remote computing device 122-1 to cause the first remote computing device 122-1 to capture data responsive to the training target. For instance, the data capture policy 140 can specify or describe data capture parameters 142 that the first remote computing device 122-1 can implement to modify operation of the first remote computing device 122-1 to facilitate the data capture responsive to the training target. For example, the first remote computing device 122-1 can update values of the data capture parameters 136 stored in the memory 126 of the first remote computing device 122-1 based on the data capture parameters 142 of the data capture policy 140. The data capture parameters 142 can include, for example, operational parameters, configuration data, conditions, constraints, or other operational limitations on the functionality of the first remote computing device 122-1 to facilitate data capture at the first remote computing device 122-1. Additionally and/or alternatively, the data capture parameters 142 can define type, density, condition, maximum or minimum dataset size, or other attributes of data useful for the training target.

In some implementations, the data capture policy 140 may be time limited. For example, in some implementations, the data capture policy 140 can specify a policy duration over which the data capture policy 140 is to be implemented. At the expiration of the policy duration, the data capture parameters 142 specified by the data capture policy may revert to original or default values. Additionally and/or alternatively, other modifications to the functionality of a remote computing device 122 may revert to prior or default characteristics.

To identify the training target and/or determine the data capture policy 140, the model hosting system 102 can consume data from any of a variety of sources. As one example, the model hosting system 102 can be in communication with a condition data source 146 capable of providing condition data to the model hosting system 102. The condition data source 146 can be, for example, a public data source or a proprietary data source. The condition data can be any suitable data indicative of a condition, whether a condition of the model hosting system 102, any of the remote computing devices 122, the environment(s) 120, or any other suitable system. For example, the condition data source 146 may be a weather system capable of providing current and/or historical weather data. As another example, the condition data source 146 may be a clock, calendar, or other temporal system capable of providing information regarding a current date, time, season, or other temporal aspect. This condition data may not necessarily be example at the remote computing devices 122. Furthermore, this condition data can be useful in improving operations of the remote computing devices 122-1. For example, it may be useful for an ambient light sensor to adjust its operation (e.g., by training a machine-learned model) based on seasonal changes in ambient light, but the ambient light sensor may lack the communication capabilities to consume seasonal data and/or to retrain its local instance of a model based on this understanding. However, by consuming condition data at the model hosting system 102, which may generally be a more powerful and/or capable system than the remote computing devices 122, and generating a data capture policy respective to a training target, the model hosting system 102 can augment the functionality of the remote computing devices 122 beyond their respective default capabilities.

In addition to condition data, in some implementations, the model hosting system 102 can determine the data capture policy 140 based on capability data associated with the remote computing devices 122. The capability data can be descriptive of one or more capabilities of the remote computing devices 122 such as, for example, computing resource availability data, supported operation data, data capture device type data, calibration history data, or other data that provides for the model hosting system to determine data capture policies 140 that are within a capability of the remote computing device 122 on which the data capture policies 140 are to be implemented. The model hosting system 102 can receive the capability through communication with the remote computing devices 122. Additionally and/or alternatively, the model hosting system 102 can store (e.g., in the memory 108) the capability data based on historical interactions with the remote computing devices 122.

Additionally and/or alternatively, in some implementations, the data capture policy 140 can be at least partially generated through interactions with one or more users. For instance, in some implementations, the model hosting system 102 can be in communication with a user computing device 148. For instance, the user computing device 148 may be a system terminal, a laptop computer system, a desktop computer system, a smartphone, or other suitable device. The user computing device 148 can provide a user with information about the model hosting system 102 and/or the remote computing devices 122. Additionally and/or alternatively, the user computing device can provide one or more input fields 149 by which the user may specify the data capture policy 140 and/or data capture parameters 142 of the data capture policy 140.

The model hosting system 102 can provide the data capture policy 140 to the remote computing devices 122 (e.g., the first remote computing device 122-1). Based on the data capture policy 140, the remote computing devices 122-1 can generate component training datasets 150. The component training datasets 150 can include a plurality of training data items 152. For instance, in the example of FIG. 1, the component training dataset 150 from the first remote computing device 122-1 includes M data items 152-1 through 152-M. The M data items 152 in the component training dataset 150 may be less than the N training data items 119 in the aggregate training dataset 118. For instance, each component training dataset 150 may comprise a portion of the aggregate training dataset 118. The model hosting system 102 can receive the component training datasets 150, aggregate the component training datasets 150 into the aggregate training dataset 118, and generate an update 154 for a model (e.g., the first machine-learned model 112, the second machine-learned model 114, or the third machine-learned model 116) by training the model on the aggregate training dataset 118. The model hosting system 102 can communicate the update 154 to the remote computing devices 122, and the remote computing devices 122 can update the local instances 130 based on the update 154.

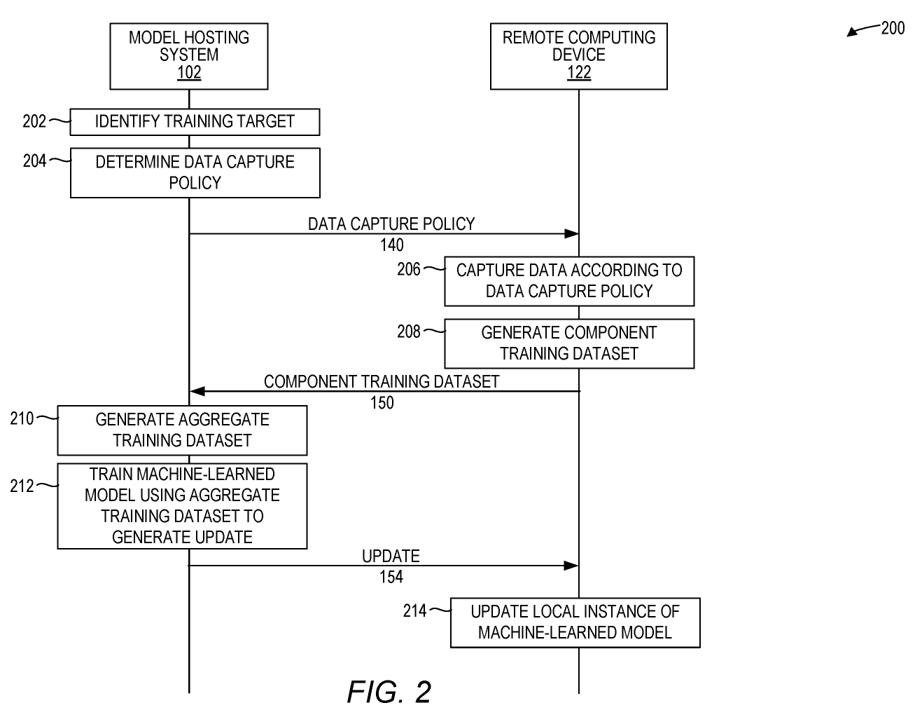

Example data flows between components described in FIG. 1 will now be discussed with reference to FIG. 2. FIG. 2 is a data flow diagram 200 according to some implementations. For instance, FIG. 2 depicts example operations and communications performed by and/or between the model hosting system 102 and the remote computing device(s) 122 (e.g., the first remote computing device 122-1) of FIG. 1.

At 202, the model hosting system 102 can identify a training target associated with training a machine-learned model, such as the first machine-learned model 112, the second machine-learned model 114, or the third machine-learned model 116. To identify the training target and/or determine the data capture policy 140, the model hosting system 102 can consume data from any of a variety of sources, as described above.

In some implementations, identifying the training target can include receiving, from a remote computing device 122, a communication descriptive of an operational scenario wherein a quality of output from the local instance 130 of the machine-learned model at the remote computing device 122 is below a threshold. For instance, the remote computing device 122 can evaluate an output quality of the local instance 130 of the machine-learned model and determine that the quality is inadequate, and therefore that the model should be trained further. Furthermore, the operational scenario can include condition data or other data descriptive of the conditions of the scenario under which the model performed poorly. The model hosting system 102 can identify the training target to improve performance of the machine-learned model in the operational scenario. As one example, if the remote computing device 122 uses an object detection model that performs poorly under rainy conditions in winter, the training target may be identified to capture more training data depicting rainy conditions in winter.

As another example, in some implementations, the model hosting system 102 can identify the training target based on an analysis of an underlying distribution of attributes of the training data (e.g., the aggregate training dataset 118) used to previously train the model. For instance, the model hosting system 102 may target a relatively uniform distribution (or another suitable distribution) for attributes of the training data. If the model hosting system 102 recognizes that the actual distribution of training data does not match the intended distribution, the model hosting system 102 can identify a training target to capture underrepresented data. The attribute can be any one or more of a domain, a data classification, an environmental condition, a system condition, a time condition, a date condition, a seasonal condition, a weather condition, a temperature condition, a density, a device type, a firmware condition, an operational condition, a network condition, or a geospatial condition. For instance, in some implementations, identifying the training target includes determining an attribute distribution associated with historical training data used to train the machine-learned model and identifying the training target based on a comparison between the attribute distribution associated with the historical training data and a target training data distribution. Furthermore, in some implementations, the comparison can be used to identify an attribute having a value in the attribute distribution that is lower than a corresponding value in the target training data distribution. The model hosting system 102 can identify the training target and/or generate the data capture policy 140 such that the data capture policy 140 is implementable by the remote computing device 122 to cause the remote computing device 122 to capture an increased amount of data having the identified attribute.

At 204, the model hosting system 102 can determine the data capture policy 140. The data capture policy 140 can be determined to cause the remote computing device 122 to capture data responsive to the training target. Furthermore, in some implementations, the data capture policy 140 can also perform load balancing, density balancing, attribute balancing, deduplication, or other administration of the system as a whole.

For instance, in some implementations, determining the data capture policy 140 can include determining a redundancy condition for the remote computing device 122 and an additional remote computing device 122 of the plurality of additional remote computing devices 122. For instance, returning to the example of FIG. 1, a redundancy condition may exist between the first remote computing device 122-1 and the second remote computing device 122-2 if both remote computing devices 122 are positioned within the same first environment 120-1 and utilize local instances 130 of the same first machine-learned model 112. The data captured by the first remote computing device 122-1 and the second remote computing device 122-2 may therefore be similar enough or identical such that the data is redundant, and the model may be trained even if some or all data from one remote computing device 122 is discarded. To address the redundancy condition, the model hosting system 102 can generate a data capture policy 140 that effectively disables some or all data capture at one of the remote computing devices 122 with the redundancy condition. For example, in response to the redundancy condition, the model hosting system 102 can generate the data capture policy 140 such that the data capture policy 140 is implementable by a remote computing device 122 to cause the remote computing device 122 to not include redundant data in the component training dataset 150 from the remote computing device 122.

Additionally or alternatively, in some implementations, the model hosting system 102 can determine a data capture policy 140 to address poor quality data from a remote computing device. For instance, in some implementations, the model hosting system 102 can determine an unsuitable quality condition for a remote computing device 122 based on prior data received from the remote computing device. Data described herein may be of poor quality in any of a number of scenarios. As one example, the data may be highly duplicative, have too high or too low of a capture frequency, be null, zero, noise, or other unintelligible data, be significantly biased or diminished, or otherwise be suboptimal. In response to the unsuitable quality condition, the model hosting system 102 can generate the data capture policy 140 such that the data capture policy 140 is implementable by the remote computing device 122 to cause the remote computing device 122 to modify its operation to improve quality of the component training dataset 150. As one example, in some implementations, the data capture policy 140 can cause the remote computing device 122 to update a software component or a firmware component. For example, the data capture policy 140 may include an instruction or packet to cause the remote computing device 122 to download or install an update to one of its components (e.g., the instructions 128). As another example, in some implementations, the data capture policy 140 can cause the remote computing device 122 to reconfigure the data capture device 134 of the remote computing device 122. For example, the remote computing device may reboot or reset the data capture device, modify some of the data capture parameters 136 relating to configuration of the data capture device 134, or otherwise reconfigure the data capture device 134. For instance, the data capture policy 140 may cause the remote computing device 122 to adjust a data capture interval of the remote computing device 122 or the data capture device 134. As another example, in some implementations, the data capture policy 140 may cause the remote computing device 122 to modify one or more communication parameters of the communication device 132, such as by causing the remote computing device to adjust a data transmission interval of the remote computing device.

The model hosting system 102 can communicate, to the remote computing device 122, the data capture policy 140 that is implementable by the remote computing device 122 to cause the remote computing device 122 to capture data responsive to the training target. At 206, the remote computing device 122 can capture data according to the data capture policy 140. For example, the remote computing device 122 can configure a data capture device 134 according to data capture parameters 142 specified by the data capture policy 140 and operate the data capture device with respect to the data capture parameters 142.

At 208, the remote computing device 122 can generate a component training dataset 150. The component training dataset 150 can include data captured by the remote computing device 122 according to the data capture policy 140. For example, in some implementations, the data in the component training dataset 150 can conform to the requirements specified by the data capture parameters 142 of the data capture policy 140. Additionally and/or alternatively, the data in the component training dataset 150 can be filtered, deduplicated, or otherwise modified from raw data captured by a data capture device 134 based on rules or heuristics specified by the data capture policy.

The remote computing device 122 can communicate the component training dataset 150 to the model hosting system 102. At 210, the model hosting system 102 can generate an aggregate training dataset 118 by aggregating the component training dataset 150 received from the remote computing device 122 with a plurality of additional component training datasets 150 from a plurality of additional remote computing devices 122. The additional remote computing devices 122 may or may not utilize the model for which the aggregate training dataset 118 will be used for training. Furthermore, the additional remote computing devices 122 may operate under different data capture policies 140 from the remote computing device 122.

For instance, returning to the example of FIG. 1, when generating an aggregate training dataset 118 for the local instances 130-3, 130-4, and 130-5 corresponding to the second machine-learned model 114, the model hosting system 102 can utilize component training datasets 150 from not only the third remote computing device 122-3, the fourth remote computing device 122-4, and the fifth remote computing device 122-5, but also from the first remote computing device 122-1, the second remote computing device 122-2, the sixth remote computing device 122-6, or other remote computing devices 122. This can be beneficial for generating meaningful updates for models and remote computing devices 122 that are less represented in the system 100. For example, the sixth remote computing device 122-6 is the only device in the example of FIG. 1 that utilizes the third machine-learned model 116 in its local instance 130-6, and could experience challenges in collecting enough training data to train the third machine-learned model 116 by only its data capture. However, by utilizing the aggregate training dataset 118 including data from the other remote computing devices 122, the sixth remote computing device 122-6 can nonetheless provide high quality performance using its local instance 130-6 of the third machine-learned model 116.

At 212, the model hosting system 102 can train the machine-learned model using the aggregate training dataset to generate an update 154 for the machine-learned model. Any suitable training process, including supervised or unsupervised learning techniques, can be utilized in accordance with the present disclosure. The update 154 can be a standalone instance of the model post-training and/or a delta compared to a prior (e.g., pre-training) version of the model. The model hosting system 102 can communicate the update 154 to the remote computing device 122. At 214, the remote computing device 122 can update its local instance 130 of the machine-learned model. For instance, the remote computing device 122 can replace its local instance 130 with the update 154 and/or apply delta operations to its local instance 130 based on the update 154.

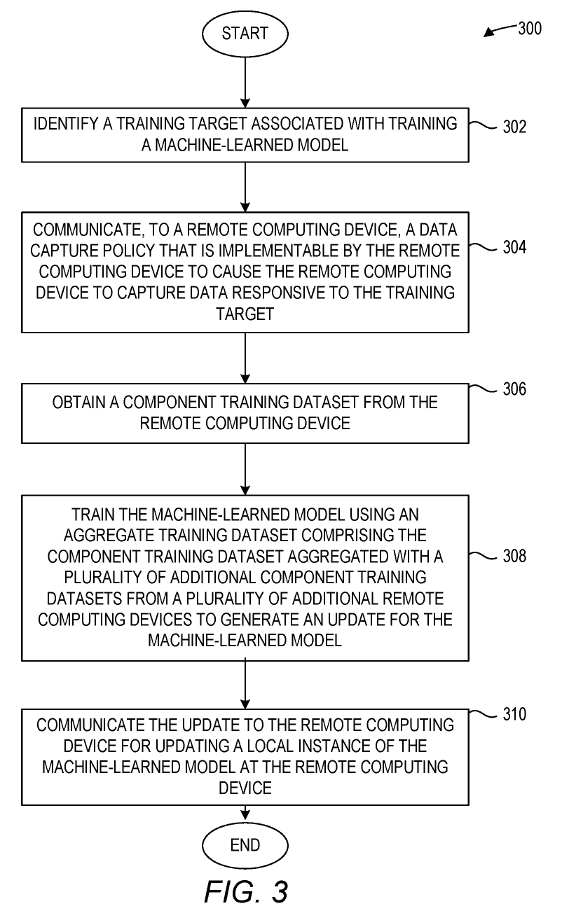

FIG. 3 depicts a flowchart diagram of an example method 300 according to some implementations. At 302, the method 300 includes identifying a training target associated with training a machine-learned model (e.g., 112, 114, 116). At 304, the method 300 includes communicating, to a remote computing device 122, a data capture policy 140 that is implementable by the remote computing device 122 to cause the remote computing device 122 to capture data responsive to the training target. At 306, the method 300 includes obtaining a component training dataset 150 from the remote computing device 122, the component training dataset 150 comprising data captured according to the data capture policy 140. At 308, the method 300 includes training the machine-learned model (e.g., 112, 114, 116) using an aggregate training dataset 118 comprising the component training dataset 150 aggregated with a plurality of additional component training datasets 150 from a plurality of additional remote computing devices 122 to generate an update 154 for the machine-learned model (e.g., 112, 114, 116). At 310, the method 300 includes communicating the update 154 to the remote computing device 122 for updating a local instance 130 of the machine-learned model (e.g., 112, 114, 116) at the remote computing device 122.

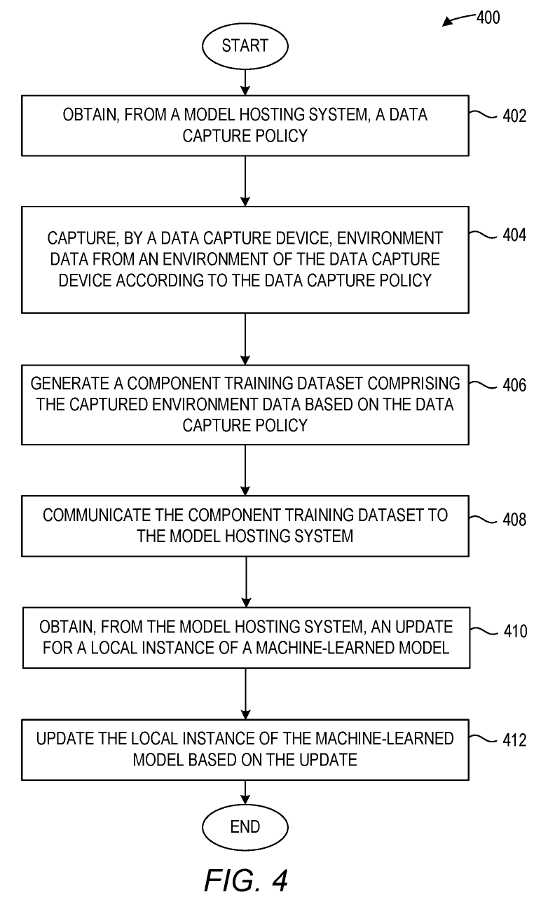

FIG. 4 depicts a flowchart diagram of an example method 400 according to some implementations. At 402, the method 400 includes obtaining, from a model hosting system 102, a data capture policy 140. At 404, the method 400 includes capturing, by a data capture device 134, environment data from an environment 120 of the data capture device 134 according to the data capture policy 140. At 406, the method 400 includes generating a component training dataset 150 comprising the captured environment data based on the data capture policy 140. At 408, the method 400 includes communicating the component training dataset 150 to the model hosting system 102. At 410, the method 400 includes obtaining, from the model hosting system 102, an update 154 for a local instance of a machine-learned model (e.g., 112, 114, 116), wherein the update 154 is generated based on the component training dataset 150 communicated from the remote computing device 122 and a plurality of additional component training datasets 150 communicated by a plurality of additional remote computing devices 122. At 412, the method 400 includes updating the local instance 130 of the machine-learned model (e.g., 112, 114, 116) based on the update 154.

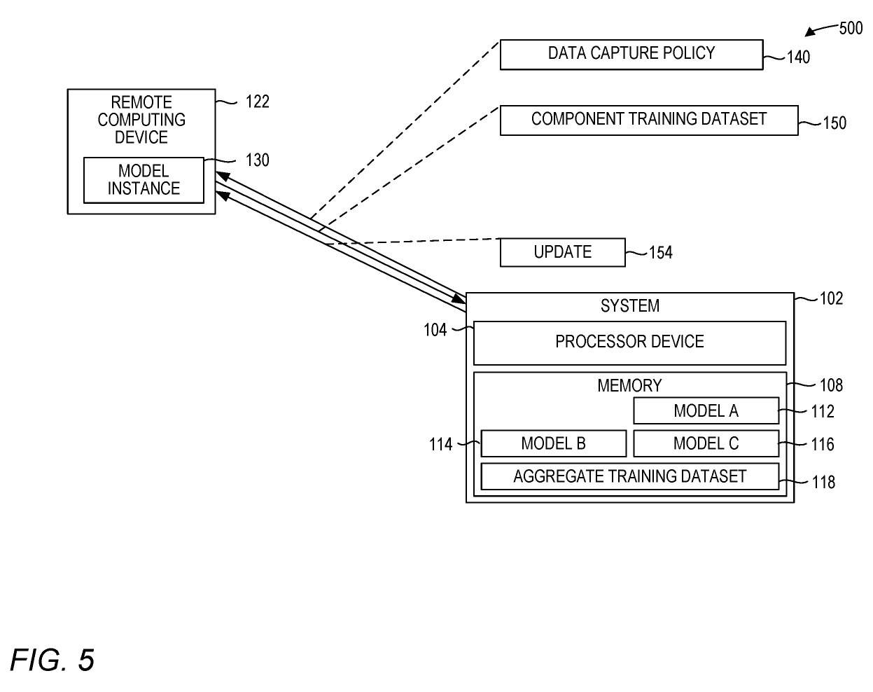

FIG. 5 is a block diagram of an example system 500 according to some implementations. The system 500 includes a processor device 104 and a memory 108 coupled to the processor device 104. The processor device 104 is to identify a training target associated with training a machine-learned model (e.g., 112, 114, 116). The processor device 104 is to communicate, to a remote computing device 122, a data capture policy 140 that is implementable by the remote computing device 122 to cause the remote computing device 122 to capture data responsive to the training target. The processor device 104 is to obtain a component training dataset 150 from the remote computing device 122, the component training dataset 150 comprising data captured according to the data capture policy 140. The processor device 104 is to train the machine-learned model (e.g., 112, 114, 116) using an aggregate training dataset 118 comprising the component training dataset 150 aggregated with a plurality of additional component training datasets 150 from a plurality of additional remote computing devices 122 to generate an update 154 for the machine-learned model (e.g., 112, 114, 116). The processor device 104 is to communicate the update 154 to the remote computing device 122 for updating a local instance 130 of the machine-learned model (e.g., 112, 114, 116) at the remote computing device 122.

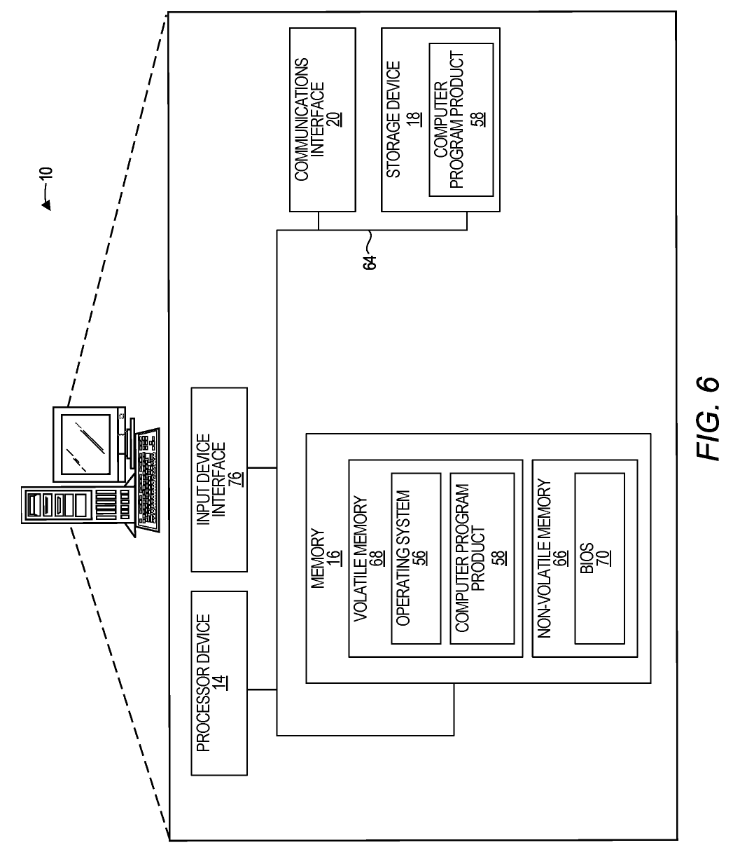

FIG. 6 is a block diagram of a computing device 10 suitable for implementing systems and methods according to one example. The computing device 10 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 10 includes a processor device 14, a system memory 16, and a system bus 64. The system bus 64 provides an interface for system components including, but not limited to, the system memory 16 and the processor device 14. The processor device 14 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The system memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the computing device 10. The volatile memory 68 may also include a high-speed RAM, such as static RAM, for caching data.

The computing device 10 may further include or be coupled to a non-transitory computer-readable storage medium such as a storage device 18, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 18 and other drives associated with computer-readable media and computer-usable media may provide non-volatile storage of data, data structures, computer-executable instructions, and the like.

A number of modules can be stored in the storage device 18 and in the volatile memory 68, including an operating system and one or more program modules, such as the data capture policy 140, which may implement the functionality described herein in whole or in part. All or a portion of the examples may be implemented as a computer program product 58 stored on a transitory or non-transitory computer-usable or computer-readable storage medium, such as the storage device 18, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the computer program product 58 in the volatile memory 68, may serve as a controller, or control system, for the computing device 10 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 14 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The computing device 10 may also include a communications interface 20, such as an Ethernet transceiver and/or a Wi-Fi transceiver, or the like, suitable for communicating with a network as appropriate or desired. The computing device 10 may also include a video port configured to interface with a display device to provide information to the user.

Individuals will recognize improvements and modifications to the preferred examples of the disclosure. All such improvements and modifications are considered within the scope of the concepts disclosed herein and the claims that follow.

What is claimed is:

1. A computer system comprising:
a non-transitory, computer-readable memory; and
a processor device coupled to the memory, the processor device to:
identify a training target associated with training a machine-learned model;
communicate, to a remote computing device, a data capture policy that is implementable by the remote computing device to cause the remote computing device to capture data responsive to the training target;
obtain a component training dataset from the remote computing device, the component training dataset comprising data captured according to the data capture policy;
train the machine-learned model using an aggregate training dataset comprising the component training dataset aggregated with a plurality of additional component training datasets from a plurality of additional remote computing devices to generate an update for the machine-learned model; and
communicate the update for the machine-learned model to the remote computing device for updating a local instance of the machine-learned model at the remote computing device.

2. The computer system of claim 1, wherein, to identify the training target, the processor device is further to:
receive, from the remote computing device, a communication descriptive of an operational scenario wherein a quality of output from the local instance of the machine-learned model at the remote computing device is below a threshold; and
identify the training target to improve performance of the machine-learned model in the operational scenario.

3. The computer system of claim 1, wherein, to identify the training target, the processor device is further to:
determine an attribute distribution associated with historical training data used to train the machine-learned model; and
identify the training target based on a comparison between the attribute distribution associated with the historical training data used to train the machine-learned model and a target training data distribution.

4. The computer system of claim 3, wherein the processor device is further to:
identify an attribute having a value in the attribute distribution that is lower than a corresponding value in the target training data distribution; and
generate the data capture policy, wherein the data capture policy is implementable by the remote computing device to cause the remote computing device to capture an increased amount of data having the attribute.

5. The computer system of claim 4, wherein the attribute comprises one or more of a domain, a data classification, an environmental condition, a system condition, a time condition, a date condition, a seasonal condition, a weather condition, a temperature condition, a density, a device type, a firmware condition, an operational condition, a network condition, or a geospatial condition.

6. The computer system of claim 1, wherein the processor device is further to:
determine a redundancy condition for the remote computing device and an additional remote computing device of the plurality of additional remote computing devices; and
in response to the redundancy condition, generate the data capture policy, wherein the data capture policy is implementable by the remote computing device to cause the remote computing device to not include redundant data in the component training dataset.

7. The computer system of claim 1, wherein the processor device is further to:
determine an unsuitable quality condition for the remote computing device based on prior data received from the remote computing device; and
in response to the unsuitable quality condition, generate the data capture policy, wherein the data capture policy is implementable by the remote computing device to cause the remote computing device to modify operation of the remote computing device to improve quality of the component training dataset.

8. The computer system of claim 1, wherein the data capture policy is implementable by the remote computing device to cause the remote computing device to update a software component or a firmware component at the remote computing device.

9. The computer system of claim 1, wherein the data capture policy is implementable by the remote computing device to cause the remote computing device to reconfigure a data capture device of the remote computing device.

10. The computer system of claim 1, wherein the data capture policy is implementable by the remote computing device to cause the remote computing device to adjust a data capture interval of the remote computing device.

11. The computer system of claim 1, wherein the data capture policy is implementable by the remote computing device to cause the remote computing device to adjust a data transmission interval of the remote computing device.

12. The computer system of claim 1, wherein the data capture policy specifies a policy duration over which the data capture policy is to be implemented.

13. A computer-implemented method, comprising:
identifying, by a computer system, a training target associated with training a machine-learned model;
communicating, by the computer system and to a remote computing device, a data capture policy that is implementable by the remote computing device to cause the remote computing device to capture data responsive to the training target;
obtaining, by the computer system, a component training dataset from the remote computing device, the component training dataset comprising data captured according to the data capture policy;
training, by the computer system the machine-learned model using an aggregate training dataset comprising the component training dataset aggregated with a plurality of additional component training datasets from a plurality of additional remote computing devices to generate an update for the machine-learned model; and
communicating, by the computer system, the update for the machine-learned model to the remote computing device for updating a local instance of the machine-learned model at the remote computing device.

14. The computer-implemented method of claim 13, wherein identifying the training target comprises receiving, from the remote computing device, a communication descriptive of an operational scenario wherein a quality of output from the local instance of the machine-learned model at the remote computing device is below a threshold; and
identifying the training target to improve performance of the machine-learned model in the operational scenario.

15. The computer-implemented method of claim 13, wherein identifying the training target comprises:
determining an attribute distribution associated with historical training data used to train the machine-learned model; and
identifying the training target based on a comparison between the attribute distribution associated with the historical training data used to train the machine-learned model and a target training data distribution.

16. The computer-implemented method of claim 15, further comprising:
identifying an attribute having a value in the attribute distribution that is lower than a corresponding value in the target training data distribution; and
generating the data capture policy, wherein the data capture policy is implementable by the remote computing device to cause the remote computing device to capture an increased amount of data having the attribute.

17. The computer-implemented method of claim 13, further comprising:
determining a redundancy condition for the remote computing device and an additional remote computing device of the plurality of additional remote computing devices; and
generating, in response to the redundancy condition, the data capture policy, wherein the data capture policy is implementable by the remote computing device to cause the remote computing device to not include redundant data in the component training dataset.

18. The computer-implemented method of claim 13, further comprising:
determining an unsuitable quality condition for the remote computing device based on prior data received from the remote computing device; and
generating, in response to the unsuitable quality condition, the data capture policy, wherein the data capture policy is implementable by the remote computing device to cause the remote computing device to modify operation of the remote computing device to improve quality of the component training dataset.

19. The computer-implemented method of claim 13, wherein the data capture policy specifies a policy duration over which the data capture policy is to be implemented.

20. A non-transitory, computer-readable memory storing instructions to cause a processor device to:
identify a training target associated with training a machine-learned model;
communicate, to a remote computing device, a data capture policy that is implementable by the remote computing device to cause the remote computing device to capture data responsive to the training target;
obtain a component training dataset from the remote computing device, the component training dataset comprising data captured according to the data capture policy;
train the machine-learned model using an aggregate training dataset comprising the component training dataset aggregated with a plurality of additional component training datasets from a plurality of additional remote computing devices to generate an update for the machine-learned model; and
communicate the update for the machine-learned model to the remote computing device for updating a local instance of the machine-learned model at the remote computing device.
